(19) United States
(12) Patent Application Publication
(10) Pub. No.: US 2006/0023418 A1
(43) Pub. Date: Feb. 2, 2006

(54) Portable drive system

(76) Inventors: Mark Solomon, Cypress, TX (US); Kevin Massaro, Houston, TX (US)

Correspondence Address: HEWLETT-PACKARD COMPANY;Intellectual Property Administration, P.O. Box 272400, Fort Collins, CO, 80527-2400, US

(21) Appl. No.: 10/901,815

(22) Filed: Jul. 29, 2004

(51) Int. Cl. G06F 1/20

(52) U.S. Cl. 361/687; 361/685

(57) ABSTRACT

A portable drive system comprises an enclosure assembly disposed about a drive device where the enclosure assembly has at least one thermal dissipation opening formed therein. The system also comprises a cover disposed over the at least one thermal dissipation opening. The cover is adapted to convectively dissipate thermal energy received via the at least one thermal dissipation opening from the drive device.

### BACKGROUND

Portable drive devices provide a convenient data storage and processing mechanism enabling portability of data files, software programs, and computer processing capabilities. Portable drive devices generally comprise at least a processor, an interface mechanism, and a storage medium. However, as software applications and processing capabilities become increasingly sophisticated, thermal energy generated by the drive device also increases. Thus, thermal energy dissipation for the portable drive device remains an important design concern. For example, to protect against dust and moisture, a sealed portable drive device may be desired. However, sealing the drive device generally limits the performance and/or power capabilities of the drive device because generally lower power and/or lower performance electronic components which generate less thermal energy must be used. Additionally, using fans and other similar types of thermal dissipation equipment increases the weight of the drive device.

### SUMMARY OF THE INVENTION

In accordance with one embodiment of the present invention, a portable drive system comprises an enclosure assembly disposed about a drive device where the enclosure assembly has at least one thermal dissipation opening formed therein. The system also comprises a cover disposed over the at least one thermal dissipation opening. The cover is adapted to convectively dissipate thermal energy received via the at least one thermal dissipation opening from the drive device.

In accordance with another embodiment of the present invention, a portable drive system comprises an enclosure assembly disposed about a drive device and having at least one thermal dissipation opening formed therein. The system also comprises a cover disposed over the at least one thermal dissipation opening and adapted to dissipate thermal energy received via the thermal dissipation opening. The system further comprises at least one ventilation gap adapted to enable thermal energy movement about the drive device toward the at least one thermal dissipation opening.

### BRIEF DESCRIPTION OF THE DRAWINGS

For a more complete understanding of the present invention and the advantages thereof, reference is now made to the following descriptions taken in connection with the accompanying drawings in which:

FIG. 1 is a diagram illustrating an embodiment of a portable drive system in accordance with the present invention;

FIG. 2 is an exploded assembly diagram illustrating the portable drive system illustrated in FIG. 1;

FIG. 3 is a cross-sectional diagram illustrating the portable drive system in FIGS. 1 and 2 taken along the line 3-3 of FIG. 1; and

FIG. 4 is a diagram illustrating another embodiment of a portable drive system in accordance with the present invention.

### DETAILED DESCRIPTION OF THE DRAWINGS

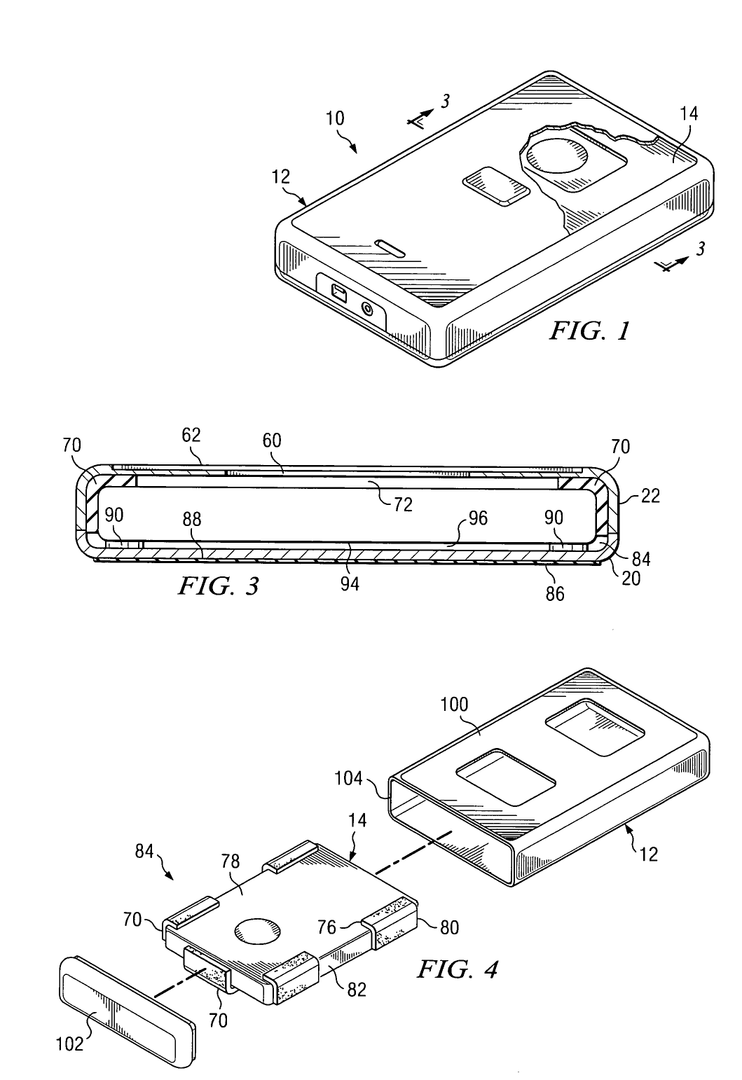

The preferred embodiments of the present invention and the advantages thereof are best understood by referring to FIGS. 1-4 of the drawings, like numerals being used for like and corresponding parts of the various drawings.

FIG. 1 is a diagram illustrating an embodiment of a portable drive system 10 in accordance with the present invention. Briefly, portable drive system 10 comprises an enclosure assembly 12 disposed about a drive device 14 to provide a ventless portable drive system 10 while providing thermal energy dissipation of drive device 14.

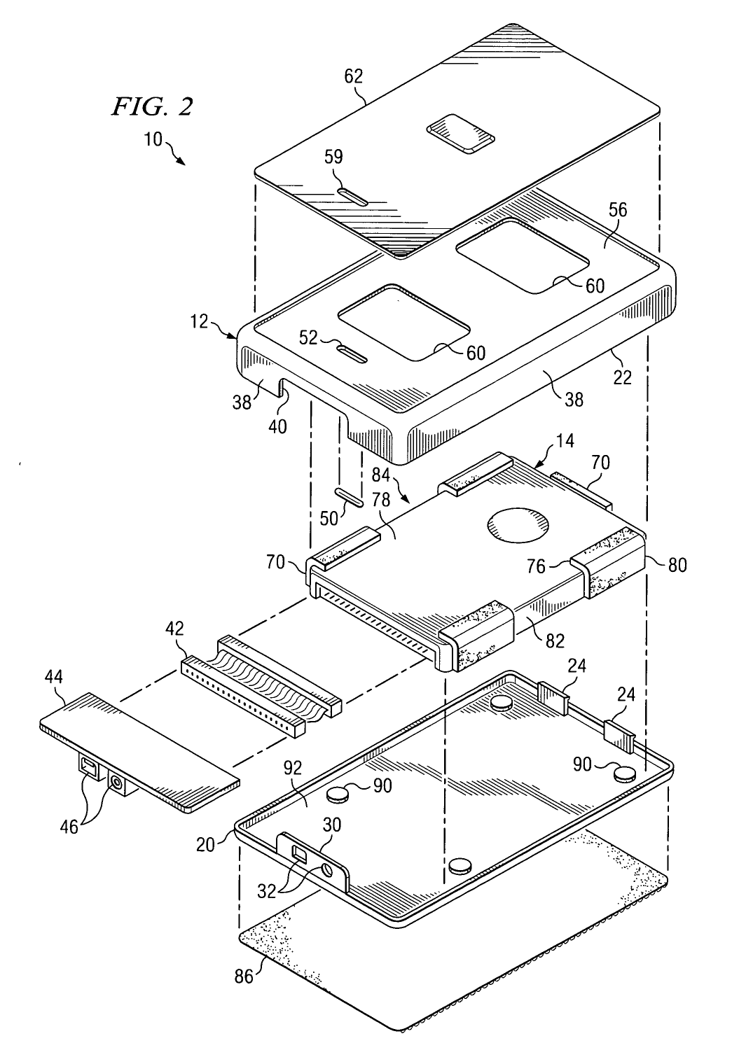

Referring to FIGS. 2 and 3, portable drive system 10 comprises a drive device 14 disposed within an enclosure assembly 12. For example, as illustrated in FIG. 2, enclosure assembly 12 comprises a base member 20 and a dissipation cover member 22 adapted to be coupled together such that drive device 14 is disposed between base member 20 and cover member 22. In the embodiment illustrated in FIGS. 2 and 3, base member 20 comprises a plurality of latch elements 24 for engaging portions of cover member 22 to secure base member 20 to cover member 22. However, it should be understood that other devices or methods may be used to secure base member 20 to cover member 22.

In the embodiment illustrated in FIGS. 2 and 3, base member 20 comprises a tab portion 30 having a plurality of access ports 32 to accommodate communicative coupling of drive device 14 through enclosure assembly 12 to an external resource such as, but not limited to, a power supply or an input/output (I/O) device. In the embodiment illustrated in FIGS. 2 and 3, cover member 22 comprises walls 38 extending toward base member 20 to facilitate enclosing drive device 14 within enclosure assembly 12. Cover member 22 also comprises a complementary cutout portion 40 adapted to cooperate with tab portion 30 of base member 20.

Drive system 10 also comprises a connector 42 disposed within enclosure 12 for communicatively coupling drive device 14 to a printed circuit board assembly 44. In the embodiment illustrated in FIGS. 2 and 3, printed circuit board assembly 44 is disposed within enclosure assembly 12 and comprises access ports 46 corresponding to locations of access ports 32 in tab portion 30 to enable communicative coupling of drive device 24 to external resource(s). Drive system 10 also comprises a status indicator 50, such as a light emitting diode or other type of status indication device, visible through an opening 52 in a lid portion 56 of cover member 22 and through an opening 59 in a cover 62.

In the embodiment illustrated in FIGS. 2 and 3, cover member 22 also comprises thermal dissipation openings 60 formed in lid portion 56. In FIG. 2, two spaced apart thermal dissipation openings 60 are illustrated. However, it should be understood that a greater or fewer quantity of dissipation openings 60 may be formed in cover member 22. In the embodiment illustrated in FIGS. 2 and 3, lid portion 56 is disposed in a recessed position relative to adjacent walls 38 of cover member 22 to accommodate placement of cover 62 onto lid portion 56 and covering of thermal dissipation openings 60. In operation, thermal energy generated by drive device 14 passes through thermal dissipation openings 60 in cover member 22 and is convectively dissipated by cover 62. For example, in a preferred embodiment, enclosure assembly 12 is formed of a non-metallic material to facilitate a lightweight drive system 10, and cover 62 is formed of a metallic material to provide enhanced thermal dissipation properties. However, it should be understood that cover 62 and enclosure assembly 12 may be formed from other materials.

In the embodiment illustrated in FIGS. 2 and 3, drive system 10 also comprises spacer elements 70 configured to form a ventilation gap 72 between lid portion 56 of cover member 22 and drive device 14. In the embodiment illustrated in FIGS. 2 and 3, five spacer elements 70 are illustrated. However, it should be understood that a greater or fewer quantity of spacer elements 70 may be used. In the embodiment illustrated in FIGS. 2 and 3, spacer elements 70 are formed having a ninety degree angled configuration such that a portion 76 extends between an upper surface 78 of drive device 14 and lid portion 56, and a portion 80 of spacer elements 70 extends between a side surface 82 of drive device 14 and wall 38 of cover member 22. However, it should be understood that spacer elements 70 may be otherwise configured. For example, an not by way of limitation, spacer elements 70 may also be configured as separate elements disposed between upper surface 78 of drive device 14 and lid portion 56 and between side surfaces 82 of drive device 14 and walls 38 of cover member 22. In some embodiments, spacer elements 70 are formed from a rubber and/or foam-like material to provide an impact and/or vibration dampening effect. However, it should be understood that spacer elements 70 may be formed from other materials.

In operation, as illustrated in FIGS. 2 and 3, spacer elements 70 extend at least partially between upper surface 78 and lid portion 56 of cover member 22 to form ventilation gap 72 between at least a portion of drive device 14 and lid portion 56 of cover member 22. Additionally, spacer elements 70 extend at least partially between side surfaces 82 of drive device 14 and walls 38 of cover member 22 to form a ventilation gap 84 between at least a portion of side surfaces 82 of drive device 14 and walls 38 of cover member 22. Thus, in the embodiment illustrated in FIGS. 2 and 3, drive device 14 is disposed spaced apart from at least a portion of enclosure assembly 12 proximate to at least one of thermal dissipation opening 60 to facilitate thermal energy movement within enclosure assembly 12 about drive device 14.

In the embodiment illustrated in FIGS. 2 and 3, system 10 also comprises a pad member 86 coupled to a supporting surface 88 of base member 20. Preferably, pad member 86 is formed of a non-skid material such as rubber. However, it should be understood that pad member 86 may be formed of other materials. Additionally, in the embodiment illustrated in FIGS. 2 and 3, system 10 comprises a plurality of spacer elements 90 disposed between an interior surface 92 of base member 20 and a lower or support surface 94 of drive device 14. In some embodiments, spacer elements 90 are formed from a rubber and/or foam-like material to provide an impact and/or vibration dampening effect. However, it should be understood that spacer elements 90 may also be formed from other materials. In operation, spacer elements 90 form a ventilation gap 96 between interior surface 92 of base member 20 and drive device 14 to facilitate thermal energy movement about drive device 14.

In operation, thermal energy generated by drive device 14 passes through dissipation openings 60 and is convectively dissipated by cover 62. Ventilation gaps 72, 84 and 96 facilitate a distributed cooling environment for drive device 14 by enabling thermal energy movement within ventilation gaps 72, 84 and 96 toward dissipation opening 60 formed in lid portion 56 of cover member 22. For example, if drive device 14 comprises or otherwise develops hot-spots, increased thermal energy generated by drive device 14 may be dissipated more efficiently by enabling transfer of the thermal energy within ventilation gaps 72, 84 and/or 96 toward dissipation opening(s) 60. In the embodiment illustrated in FIGS. 2 and 3, thermal dissipation opening(s) 60 are formed having a generally rectangular geometry or configuration. However, it should be understood that other geometries may be used for dissipation openings 60.

FIG. 4 is a diagram illustrating another embodiment of portable drive system 10 in accordance with the present invention. In the embodiment illustrated in FIG. 4, enclosure assembly 12 comprises an envelope-type cover member 100 and an end cover 102. In operation, drive device 14 and spacer elements 70 are slid into cover member 100, spacer elements 70 forming ventilation gaps 72, 84 and 96 as described above to facilitate a distributed cooling environment for drive device 14, and end cover 102 is secured to an end 104 of cover member 100 to enclose drive device 14 within cover member 100. End cover 102 may be secured to end 104 of cover member 100 using clips, fasteners, or any other type of attachment method.

Thus, embodiments of the present invention provide a lightweight and ventless portable drive system 10 enabling efficient thermal dissipation of electronic devices disposed within system 10. For example, embodiments of the present invention provide ventilation gaps between a drive device and an enclosure assembly to facilitate movement of thermal energy towards thermal dissipation openings formed in the enclosure assembly. Additionally, embodiments of the present invention provide a virtually sealed drive system while convectively dissipating thermal energy generated by the drive system.

What is claimed is:

1. A portable drive system, comprising:
an enclosure assembly disposed about a drive device, the enclosure assembly having at least one thermal dissipation opening formed therein; and
a cover disposed over the at least one thermal dissipation opening, the cover adapted to convectively dissipate thermal energy received via the at least one thermal dissipation opening from the drive device.

2. The system of claim 1, wherein the enclosure assembly comprises a cover member and a base member, the cover member having the at least one thermal dissipation opening formed therein.

3. The system of claim 1, further comprising a spacer element disposed at least partially between the enclosure assembly and the drive device.

4. The system of claim 1, wherein the drive device is disposed spaced apart from at least a portion of the enclosure assembly proximate to the at least one thermal dissipation opening.

5. The system of claim 1, wherein the at least one thermal dissipation opening comprises a plurality of spaced apart thermal dissipation openings.

6. The system of claim 5, the cover disposed over each of the plurality of spaced apart thermal dissipation openings.

7. The system of claim 1, further comprising a rubber pad member disposed on a supporting surface of the enclosure assembly.

8. The system of claim 1, the cover formed of a metallic material.

9. The system of claim 1, further comprising at least one access port extending through the enclosure assembly for coupling the drive device to an external resource.

10. The system of claim 1, further comprising at least one ventilation gap disposed between the drive device and the enclosure assembly.

11. A portable drive system, comprising:
means for enclosing a drive device, the enclosing means having at least one thermal dissipation opening formed therein; and
means for covering the dissipation means, the covering means adapted to convectively dissipate thermal energy received via the at least one thermal dissipation opening from the drive device.

12. The system of claim 11, further comprising means for spacing, at least partially, the enclosing means apart from the drive device proximate to the dissipation means.

13. The system of claim 11, further comprising means for enabling access through the enclosing means for coupling the drive device to an external resource.

14. The system of claim 11, wherein the means for covering the dissipation means comprises a metallic cover means.

15. The system of claim 11, further comprising means for forming at least one ventilation gap disposed between the drive device and the enclosing means.

16. A portable drive system, comprising:
an enclosure assembly disposed about a drive device, the enclosure assembly having at least one thermal dissipation opening formed therein;
a cover disposed over the at least one thermal dissipation opening and adapted to dissipate thermal energy received via the thermal dissipation opening; and
at least one ventilation gap adapted to enable thermal energy movement about the drive device toward the at least one thermal dissipation opening.

17. The system of claim 16, further comprising at least one spacer element disposed at least partially between at least a portion of the enclosure assembly and the drive device.

18. The system of claim 16, further comprising at least one access port extending through the enclosure assembly to facilitate coupling of the drive device to an external resource.

19. The system of claim 16, further comprising a rubber pad member coupled to a base member of the enclosure assembly.

20. The system of claim 16, wherein the at least one thermal dissipation opening comprises a plurality of spaced apart thermal dissipation openings formed in the lid portion.

21. The system of claim 16, the enclosure assembly formed from a non-metallic material.

22. The system of claim 16, the at least one ventilation gap disposed between a side surface of the drive device and the enclosure assembly.

23. The system of claim 16, the at least one ventilation gap disposed between a support surface of the drive device and the enclosure assembly.

24. The system of claim 16, the at least one ventilation gap disposed between an upper surface of the drive device and the enclosure assembly.
